(19) United States
(12) Patent Application Publication
(10) Pub. No.: US 2024/0227319 A9
(43) Pub. Date: Jul. 11, 2024

(54) FIBER-REINFORCED COMPOSITE MATERIAL HAVING STYRENE (CO)POLYMER AND NATURAL FIBERS

(71) Applicant: ENSINGER GMBH, Nufringen (DE)

(72) Inventors: Nils BECKER, Koeln (DE); Felix KLAUCK, Madrid (ES); Pierr JUAN, Frankfurt am Main (DE); Jonathan LIMBECK, Pulheim (DE); Konstantin SUHRE, Lengerich (DE)

(21) Appl. No.: 18/547,087

(22) PCT Filed: Feb. 22, 2022
(86) PCT No.: PCT/EP2022/054357

§ 371 Date: Aug. 18, 2023

(30) Foreign Application Priority Data
Feb. 23, 2021 (EP) 21158765.4

(51) Int. Cl. B29C 70/06; B29C 70/50; B29K 25/00; B29K 311/10; B29L 31/10

(52) U.S. Cl. CPC B29C 70/06; B29C 70/50; B29K 2025/08; B29K 2311/10; B29K 2995/0022; B29K 2995/0026; B29K 2995/0063; B29K 2995/0097; B29L 2031/10

(57) ABSTRACT

A fiber-reinforced composite material (K), containing a thermoplastic polymer matrix and at least one natural-fiber component, is technically advantageous if it contains at least 45% (v/v) of a styrene (co)polymer (A) as polymer matrix, 30-55% (v/v) of a natural-fiber sheet material (B) as natural-fiber component, optionally 0-10% (v/v) of an additional polymer component (C), and optionally 0-10% of at least one additive (D), the volume percentages of components (A) to (D) adding up to 100 volume percent of the composite material (K).

The invention relates to a fiber-reinforced composite material that comprises a thermo plastic polymer matrix composed of at least one styrene (co)polymer and at least one natural fiber component. This composite material can for example be produced by pressing of the layer assembly with application of pressure and heat. The material combines structural rigidity, good processability, and pleasing esthetics, making it suitable for a variety of uses, including in the high performance sector. Compared to known materials, the fiber-reinforced composite material is distinguished by its high surface gloss.

Fiber-reinforced composite materials have been known for years and consist of a large number of reinforcing fibers embedded in a polymer matrix. The areas of application of fiber-reinforced composite materials are diverse. For example, they are used in the automotive and aviation industries. The materials should among other things prevent breakage or other fragmentation of the matrix and reduce the risk of accidents caused by scattered pieces of building components. Many fiber-reinforced composite materials are able to absorb relatively high forces under stress before the material fails. The fiber-reinforced composite materials of the present invention are distinguished by comparison with conventional materials in their high strength and rigidity allied with low density and other advantageous properties such as good resistance to aging and corrosion.

The strength and stiffness of the composite materials can be tailored to the direction and nature of stress. The fibers are here particularly important for the strength and rigidity of the fiber composite material. In addition, the fiber arrangement determines the mechanical properties of the fiber composite material. The matrix serves in particular to direct most of the force to be absorbed to the individual fibers and to keep the spatial arrangement of the fibers in the desired orientation. Since it is possible to vary both the type of fiber and the matrix materials, numerous combinations of fibers and matrix materials are possible.

For the highest demands on the strength and rigidity of fiber composite materials, continuous fiber-reinforced composites are employed. The length of the fibers is here limited only by the final structural component, which is introduced especially in the form of a woven or non-crimp fabric and at a high resulting fiber volume content. This results in a high degree of specific interface between the fiber system and matrix in the building component or semifinished product. In contrast to the impregnation of short fibers in injection molding processes, good impregnation of continuous fibers or of woven or non-crimp fabrics with the polymer matrix is often technically challenging.

The mechanical demands on a fiber-reinforced composite material notwithstanding, esthetic and economic demands too must be met. Since fiber-reinforced materials have the potential to be used in a variety of sectors, it needs to be possible to produce them with high-quality surfaces without this necessitating further, complex work steps. For many uses, good optical properties are important, such as the possibility of using the fiber-reinforced composite materials to achieve elements or components having smooth surfaces (low surface rippling, lack of holes or indentations, etc.), decorativeness, and high transparency. Up to now, it has not been possible to achieve these optical properties with many fiber-reinforced composite materials. Economical and environmentally friendly production of the fiber-reinforced composite material is also desirable. Recycling is like wise important.

It is therefore desirable to provide lightweight, fiber-reinforced composite materials that have a wide range of uses. Good optical properties and the possibility of producing a variety of elements having glossy, structured or smooth surfaces from the fiber-rein forced composite material are desirable.

The fiber-reinforced composite material should be easy to process, largely inert to common solvents, have good resistance to stress cracking, and have a glossy, textured or smooth surface.

Various composite materials comprising thermoplastics and fibers have already been described in the prior art.

WO 2016/170104 relates to a composite material containing 30% to 95% by weight of a thermoplastic material, 5% to 70% by weight of reinforcing fibers, and 0% to 40% by weight of further additives. The thermoplastic material should have good processability; the MVR (220/10) is reported as 10-70 cm³/10 min.

WO 2008/058971 describes molding compounds having good mechanical properties in which two reinforcing fibers with different properties are used. The reinforcing fibers are each used with different adhesion promoter compositions, which give rise to different fiber-matrix adhesions. The reinforcing fibers need to be introduced into the matrix in the form of complex networks.

Such an approach requires an undesirably complex and labor-intensive production process.

WO 2008/119678 discloses glass fiber-reinforced compositions having mechanical properties that are improved by the use of maleic anhydride-containing styrene copolymer. It is however the use of short fibers that is taught.

US 2011/0020572 describes organic sheet components with a hybrid design having a highly flowable polycarbonate component and suitable additives, such as hyperbranched polyesters, ethylene/(meth)acrylate copolymers or low-molecular-weight polyalkylene glycol esters.

WO 2008/110539 teaches single-layer composites in which glass fibers are embedded in a molding compound.

WO 2014/163227 discloses a process for producing composite panels. CA-A 2862396 describes a process for producing composite materials consisting of a core structure and at least one surface panel that is bonded to the core structure.

Van de Velde et al. (2001) describe flax fibers as reinforcement for (thermoplastic) materials in “Thermoplastic pultrusion of natural fibre reinforced composites, Composite Structures”, volume 54 (2-3), 355-360. The production process for the materials presented here as the method of choice is pultrusion.

WO 2016/170131 describes the use of a fiber composite material composed of different layers that has a sandwich structure and comprises a foam component as one layer. WO 2012/104436 describes a composite material based on a natural fiber-reinforced plastic and comprises at least one layer of a spunlace nonwoven composed of natural fibers as reinforcing material.

WO 2016/170148 describes a process for producing a fiber composite material composed of amorphous, modified polymers having reinforcing fibers. These organic sheets are composed of a thermoplastic molding compound and reinforcing fibers. The molding compound has a chemically reactive functionality; the surface of the reinforcing fiber is silane-treated.

WO 2016/170103 relates to a fiber composite material W having increased translucency, in which the copolymer forms bonds with the surface of embedded fibers through functional groups.

WO 2016/170145 describes a thermoplastic fiber composite material having a layered structure and also the use and production thereof by introducing a sheet material into a thermoplastic matrix.

WO 2016/026920 describes fiber composite materials based on polylactic acid that can comprise various natural fibers.

WO 2019/063620 relates to fiber-reinforced composite materials comprising at least one continuous fibrous reinforcement material in combination with at least one essentially amorphous matrix polymer composition. WO 2019/063621 relates to the production of such fiber-reinforced composites.

WO 2019/063625 describes fiber-reinforced composite materials having improved fiber-matrix adhesion and composed of at least 50% by weight of continuous reinforcement material and an essentially amorphous matrix. WO 2019/063626 relates to the use of such composite materials as starting material in a thermoforming process for producing shaped articles.

With regard to the prior art, one object is to provide a composite material that is easy to process, is largely inert to a large number of solvents, has good resistance to stress cracking and (flexural) strength properties, and that also meets good optical and esthetic requirements, such as surface gloss and/or surface structure. Production should be executed with little technical effort and few work steps. The composite material should be lightweight (low density) and preferably easy to recycle.

It was surprisingly found that this object is achieved by the described fiber-reinforced composite materials comprising at least one natural fiber as reinforcement material (B) in combination with a thermoplastic polymer matrix composed of at least one styrene (co)polymer (A). They have better (surface) properties than composite materials having different thermoplastic polymer matrices.

The specific combination of at least one natural fiber, such as flax, as reinforcement material (B) with a thermoplastic polymer matrix composed of at least one styrene (co)polymer (A) under mild conditions permits the production of composite material that has particularly glossy surfaces without further process steps, such as coating steps, being necessary for this.

The invention relates more particularly to a fiber-reinforced composite material (K) comprising a thermoplastic polymer matrix and at least one natural fiber component, the composite material (K) containing (or consisting of):
at least 45% (v/v), especially 45-70% (v/v), of at least one styrene (co)polymer (A), frequently styrene-acrylonitrile, as a polymer matrix;
30-55% (v/v), especially 32-50% (v/v), of at least one natural fiber sheet material (B) as a natural fiber component;
optionally 0-10% (v/v), especially 0-9% (v/v), frequently 0.1-9% (v/v), of at least one further polymer component (C) that is different from component (A); and
optionally 0-10% (v/v), especially 0.05-5% (v/v), of at least one additive (D), where the volume percentages of components (A) to (D) together add up to 100 percent by volume of the composite material (K).

In the composite material (K), the natural fiber sheet material (B) frequently consists of natural fibers from the group consisting of: flax fiber, cotton fiber, kenaf fiber, jute fiber, hemp fiber, cellulose fiber, sisal fiber, chitin fiber, keratin fiber, bamboo fiber, coconut fiber; and/or of pretreated natural fibers from the group consisting of: flax fiber, cotton fiber, kenaf fiber, jute fiber, hemp fiber, cellulose fiber, sisal fiber, chitin fiber, keratin fiber, bamboo fiber, coconut fiber. Flax fibers are particularly suitable. The above natural fiber sheet materials differ not just in their processability, but also in their density; the density at 20° C. (ISO 1183) is for example 1.3-1.45 g/cm³ for flax fibers and 1.1-1.2 g/c³ for coconut fibers.

In the composite material (K), the styrene (co)polymer (A) preferably comprises at least one styrene-acrylonitrile copolymer and/or at least one a-methyl-styrene-acrylonitrile co polymer. Component (A) may also comprise, for example, a modified S-AN copolymer, for example a maleic-anhydride-modified SAN. Combinations of two different SAN co polymers of differing AN content and an S-AN-MSA copolymer component have likewise been found to be especially useful as component (A) for the composite material (K).

In the composite material (K), the natural fiber sheet material (B) may be a flax fiber sheet material, for example a woven fabric. In the composite material (K), a fiber fabric having a linear mass density of 100-600 tex, preferably 150-450 tex, may for example be used as the natural fiber sheet material (B). This natural fiber sheet material (B) frequently has a basis weight of 100-600 g/m², preferably 150-450 g/m².

At least one additive (D) may be used in the composite material (K); this can for example be a release agent or a lubricant. The additive(s) are frequently used in an amount of from 0.05-5% (v/v) based on the total volume of the composite material.

The composite material (K) frequently contains (or consists of)
45-60% (v/v) of at least one styrene (co)polymer (A);
32-50% (v/v) at least one natural fiber sheet material (B);
0-9% (v/v) of at least one further polymer component (C) that is different from (A); and
0.05-5% (v/v) of at least one additive (D).

In one embodiment, the composite material (K) contains (or consists of)
45-55% (v/v) of at least one styrene (co)polymer (A);
40-50% (v/v) at least one flax fiber sheet material (B);
0-5% (v/v) of at least one further polymer component (C) that is different from (A); and
0.05-5% (v/v) of at least one additive (D).

The composite material (K) of the invention has in particular a high gloss. In gloss measurements in accordance with the ISO 2813 (2015) standard it preferably has a 20° gloss of at least 40 and a 60° gloss of at least 70.

In the composite material (K) of the invention, the polymer matrix preferably has high transparency. The styrene (co)polymer (A) frequently has such high transparency that the natural fibers of the natural fiber sheet material (B) are (easily) visible on the surface of the composite material (K). This allows a natural and visually appealing impression to be achieved. Coatings can often be dispensed with.

The invention also provides a process for producing a fiber-reinforced composite material (K), as described above, said process including the following process steps a) to d):
a) forming a layer assembly of at least one thermoplastic layer composed of styrene (co)polymer (A), optionally comprising the further polymer component (C) and/or additive component (D);
b) forming a layer assembly of at least one layer of the natural fiber sheet material (B);
c) pressing the stacked layers of polymer matrix and natural fiber sheet materials in a heated tool at a temperature of 160-240° C., preferably 180-220° C., and at a pressure of 15-25 bar, preferably 18-22 bar, and
d) cooling the fiber-reinforced composite material (K) to a temperature below the glass transition temperature (T_{g}) of the styrene (co)polymer (A), at a pressure of 15-25 bar, preferably 18-22 bar.

The process for producing a fiber-reinforced composite material (K) preferably includes the following process steps a) to d):
a) forming a layer assembly of at least one, especially at least two, thermoplastic layers having an average thickness of 0.05-0.75 mm, especially an average thickness of 0.1-0.5 mm, composed of the styrene (co)polymer (A), optionally comprising the further polymer component (C) and/or additive component (D);
b) forming a layer assembly of at least one, especially at least two, layers of the natural fiber fabric (B) having an average thickness of 0.05-0.75 mm, especially an average thickness of 0.1-0.5 mm;
c) pressing the stacked layers of natural fiber fabric (B) between thermoplastic layers comprising (A) in a heated tool at a temperature of 180-230° C. and at a pressure of 15-25 bar, and
d) cooling the fiber-reinforced composite material (K) to a temperature below the glass transition temperature (T_{g}) of the styrene (co)polymer (A), at a pressure of 15-25 bar.

The layer assembly may have for example 2 to 20 layers, frequently 3 to 12 layers; it may include, for example:
A-B-A-B-A
A-B-A-B-A-B-A
A-A-B-A-A-B-A-A
A-A-B-A-A-B-A-A-B-A-A.

Variations in the respective layer thicknesses (details relate in each case to individual layers) are also possible.

In the process for producing a fiber-reinforced composite material (K), the composite material (K) obtained preferably has an average thickness of <4 mm, preferably <3.5 mm, more preferably <3.0 mm.

The invention relates also to the use of a composite material (K) as described or as produced by a process according to the description as a structural element for building components and/or esthetic applications.

The following uses are of particular relevance:
(i) starting material for producing shaped articles by a thermoforming process;
(ii) film material or coating;
(iii) packaging material; or
(iv) textile sheet material or fabric.

In a preferred process for producing a fiber-reinforced composite material (K) of the invention, the composite material (K) obtained has an average overall thickness of <3.0 mm or <2.0 mm. The minimum thickness of the composite material (K) is usually 0.1 mm, frequently 0.1 mm. The material can be used uncoated, but can also be treated further.

The preferred components are described below.

Component (A) (Thermoplastic Polymer Matrix)

The composite material (K) contains at least 45% (v/v), generally 45-70% (v/v), based on the total volume of the thermoplastic molding compound, of styrene (co)polymer(s) as component A. The thermoplastic molding compound of the invention comprises as component A one or more styrene (co)polymers. Any suitable comonomers may be pre sent in the copolymers in addition to styrene. There are preferably one or more styrene-acrylonitrile copolymers and/or one or more alpha-methyistyrene-acrylonitrile copolymers.

A mixture of more than one SAN copolymer with a MAH-modified styrene-acrylonitrile copolymer is frequently used. However, all styrene-acrylonitrile copolymers, alpha-methylstyrene-acrylonitrile copolymers or mixtures thereof known to those skilled in the art that are described in the literature may in principle be used as component A. Likewise preferred as component A are mixtures of said styrene-acrylonitrile copolymers and/or a-methylstyrene-acrylonitrile copolymers with one another.

The thermoplastic component A usually has a density at 20° C. (ISO 1183) of 1.01 to 1.15 (g/cm³).

Component (B) (natural fiber component)

The natural fiber sheet material (B) that can be used in the context of the invention comprises at least one natural fiber and/or fiber derived from a natural material. According to the invention, component B is present in the composite material (K) in a proportion of from 30% to 55% (v/v), preferably 32 to 50% (v/v), based on the total volume. It is also possible to use a combination of more than one natural fiber.

Fibers are materials that continuously form discrete, elongated pieces, much like pieces of thread, from which sheet materials can be made. Natural fibers can come from various (natural) sources, for example from the group consisting of: kenaf fibers, jute fibers, flax fibers, hemp fibers, cellulose fibers, cotton fibers, sisal fibers, chitin fibers, keratin fibers, and coconut fibers.

The fiber-reinforced composite material K preferably comprises a flax fiber sheet material as component B.

According to a preferred embodiment of the present invention, the linear mass density is 100-600 tex, preferably 150-450 tex, and the basis weight is 100-600 g/m², preferably 150-450 g/m².

Component B usually has a density at 20° C. (ISO 1183) of from 1.1 to 1.6 (g/cm³), frequently, for example in the case of flax fibers, of from 1.3 to 1.45 (g/cm³).

### Component (C)

Component C may be a further polymer component that differs from component A. Component C is present in the composite material in a proportion of from 0% to 10% (v/v), frequently 0.05 to 5%, based on the total volume. Of particular interest as component C are, for example, polyethylene, polypropylene, polycarbonate, polyamide, PLA, etc.

The further polymer component C usually has a density at 20° C. (ISO 1183) of 0.9 to 1.3 (g/cm³).

### Component (D) (Additives)

Component D is one or more additives present in the fiber-reinforced composite material in a proportion of from 0% to 10% (v/v) based on the total volume. In addition, the thermoplastic composition may comprise additives within a range in which the properties of the composition of the present invention are unimpaired.

Component D consists of one or more additives, preferably selected from the group consisting of release agents, lubricants, pigments, mold release agents, waxes, dyes, flame retardants, antioxidants, stabilizers against the action of light, heat and UV stabilizers, pulverulent fillers, reinforcing agents, antistats, adhesion promoters (wetting agents) or mixtures thereof.

Particular preference is given to release agents or lubricants in an amount of from 0.05% to 5% (v/v) based on the total volume. The additive component D frequently has—depending on type—a density at 20° C. (ISO 1183) in the range from 0.9 to 2.0 (g/cm³).

### Production Process

The production of the fiber-reinforced composite material (K) essentially comprises the forming of a layer assembly (from the components (A) and (B)), pressing in a tool under the action of heat and pressure, and cooling of the material.

As the first steps in the process, the layer assembly is executed from at least one thermoplastic layer composed of styrene (co)polymer (A), optionally comprising further polymer component (C) and/or the additive component (D), and at least one layer of the natural fiber sheet material (B). The components are preferably arranged in layers stacked on top of one another (e.g. natural fiber fabric (B) between styrene (co)polymer (A): (A)-((B)-(A))n.

Pressing then takes place by means of a melting process of the styrene (co)polymer and bonding of the layers of components A and B. This process is carried out in a heated tool at a temperature of 160-240° C. and at a pressure of 15-25 bar. The temperature is preferably 180-220° C. and the pressure is preferably 8-22 bar. Finally, the fiber-reinforced composite material is cooled under pressure in the pressing tool to a temperature below the glass transition temperature (T_{g}) of component (A).

### Uses

Its structural, mechanical, and esthetically advantageous properties mean that the fiber-reinforced composite material (K) offers a wide range of uses.

It is suitable as a starting material for producing shaped articles by a thermoforming process, as a film material or as a coating, as a packaging material or as a textile sheet material or fabric. A particularly preferred use is as a lightweight structural element for building components and/or esthetic applications. The material can be easily reused and recycled.

The invention is elucidated in more detail by the examples and claims.

### EXAMPLES

Materials Used

Two different thermoplastic molding compounds (A1) and (A2) are produced:
A1) SAN copolymer composition containing:
(A1.1) 33.23% by weight of styrene-acrylonitrile copolymer, 22.4-24.4% by weight of acrylonitrile, MVR (220° C./5 kg)=19.0-29.0 cm³/10 min, Vicat B50=96.0-102.0° C., viscosity=58.0-66.0 cm³/g
(A1.2) 33.23% by weight of styrene-acrylonitrile copolymer, 25-29% by weight of acrylonitrile, MVR (220° C./10 kg)=80-120 cm³/10 min
(A1.3) 33.24% by weight of styrene-acrylonitrile-maleic anhydride copolymer, 23.5-26.0% by weight of acrylonitrile, viscosity=61.0-67.5 cm³/g

The densities of these styrene-acrylonitrile copolymers are approx. 1.08 g/cm³.
(A1.4) 0.30% by weight of PETS (pentaerythritol tetrastearate) as release agent, additive having a density of 0.94 g/cm³.
A2) for comparative example: Polypropylene composition containing:
(A2.1) 94.35% by weight of a PP homo- or copolymer with an MFR (230/2.16) of 80-120 g/10 min, flexural modulus 1550 MPa, Izod (23° C.) 5.5 kJ/m², impact copolymer, nu cleated, antistat, Rigidex P 380-H100 (from Ineos Olefins & Polymers), density 0.90 g/cm³.
(A2.2) 5% by weight of a polar-functionalized polypropylene with grafted maleic anhydride, MFR (190/0.325) 9-13 g/10 min, grafted maleic anhydride 0.17-0.21% by weight, Priex 20093 from Byk
(A2.3) 0.65% by weight of a mold release agent based on glycerol monostearate, additive (Dimodan HP, from Danisco).

The density of the polypropylene molding compound (A2) is 0.90 g/cm³.

The natural fiber component (B) used in the experiments was:

Flax fiber fabric: flax fiber twill fabric 2/2, basis weight 300 g/m², 300 tex yarn in warp and weft, from manufacturer Bcomp (CH); ampliTex Art. No. 5040), density 1.45 g/cm³.

Production of the respective fiber-reinforced composite material (K)

To produce the fiber-reinforced composite materials (K), various layer assemblies composed of a thermoplastic polymer matrix (as a film) and natural fiber components (fiber fabric) were provided in a static hot press (Vogt P400S). The pressing tool was heated to the desired temperature. The respective layers of the composite material underwent pressing under pressure for a period T1 (for example a few seconds). Finally, the tool was cooled for a period T2 (for example a few minutes) and the material was removed.

In the examples, flax fiber fabric (ampliTex 5040, 300 g/m², 300 tex) was used as the natural fiber fabric (B), and, as thermoplastic component (A), SAN copolymer film (150 μm) in the inventive example (see above) or a PP thermoplastic film (135 μm) in the comparative example, as characterized above.

The layers underwent pressing at a temperature of 210° C. under a pressure of 20 bar for a period T1 of 5 s. The tool was then cooled to 60° C. over a period T2 of 25 min at a pressure of 20 bar. The composite material was then removed and investigated mechanically, optically and in respect of its surface.

The SAN layer in the inventive composite material had (in each case) an average thickness of 0.150 mm.

The PP layer in the comparative composite material had (in each case) an average thick ness of 0.135 mm. The flax fiber fabric in the inventive composite material had (in each case) an average thickness of 0.207 mm. The flax fiber fabric in the comparative composite material likewise had an average thickness of 0.207 mm.

Table 1 shows parameters for the fiber-reinforced composite materials (K) produced

| | | Comparative |
|---|---|---|
| | Example | example |
| Layer structure | SAN | PP |
| | Flax | Flax |
| | SAN | PP |
| | Flax | Flax |
| | SAN | PP |
| SAN-based [μm] | 450 | — |
| PP-based [μm] | — | 405 |
| Fiber fabric [μm] | 414 | 414 |
| Calculated thickness [μm] | 864 | 819 |
| % (v/v) of thermoplastic matrix | 52% | 49% |
| % (v/v) of fiber fabric | 48% | 51% |

The measured total thickness after experimental production was slightly greater than the calculated thickness of the respective composite material. The inventive composite material contained about 45% by weight of polymer matrix and about 55% by weight of fiber fabric. The PP-based composite material contained about 37% by weight of polymer matrix and about 63% by weight of fiber fabric.

The fiber-reinforced composite materials (K) obtained were investigated mechanically and characterized by gloss measurements in accordance with the ISO 2813 (2015) standard.

The materials can be mechanically characterized via the impact strength, notched impact strength, etc. The storage stability at various temperatures and humidities can also be comparatively investigated.

Table 2 shows the results of the gloss measurement for characterization of the fiber-reinforced composite material (K)

| | | Comparative |
|---|---|---|
| | Example | example |
| 60° gloss | 89.9 | 67.9 |
| 20° gloss | 55.9 | 23.0 |

It was found that the inventive fiber-reinforced composite material (K) with styrene copolymer as thermoplastic polymer matrix (A) can be used in a simple production process to obtain a composite material having low density, good mechanical properties, and also significantly increased gloss (e.g. 20° gloss or 60° gloss).

This material is also ecologically advantageous, for example it can be readily supplied to a recycling process.

The shaped articles produced therefrom were esthetically pleasing, mechanically resilient, and readily storable.

Analogous composite materials can be readily produced in a corresponding manner with other natural fiber fabrics too, especially ones based on cotton fiber, kenaf fiber, jute fiber, hemp fiber, cellulose fiber, sisal fiber, chitin fiber, keratin fiber, bamboo fiber, and coconut fiber and/or from pretreated natural fibers.

1-15. (canceled)

16. A fiber-reinforced composite material (K) comprising a thermoplastic polymer matrix and at least one natural fiber component,
the composite material (K) containing:
at least 45% (v/v) of at least one styrene (co)polymer (A) as polymer matrix;
30-55% (v/v) of at least one natural fiber sheet material (B) as a natural fiber component;
optionally 0-10% (v/v) of at least one further polymer component (C) that is different from component (A); and
optionally 0-10% (v/v) of at least one additive (D),
wherein the volume percentages of components (A) to (D) together add up to 100 percent by volume of the composite material (K).

17. The composite material (K) of claim 16, wherein the natural fiber sheet material (B) is formed from natural fibers selected from the group consisting of: flax fiber, cotton fiber, kenaf fiber, jute fiber, hemp fiber, cellulose fiber, sisal fiber, chitin fiber, keratin fiber, bamboo fiber, and coconut fiber; and/or of pretreated natural fibers selected from the group consisting of: flax fiber, cotton fiber, kenaf fiber, jute fiber, hemp fiber, cellulose fiber, sisal fiber, chitin fiber, keratin fiber, bamboo fiber, and coconut fiber.

18. The composite material (K) of claim 16 or claim 17, containing 45-70% (v/v) of the at least one styrene (co)polymer (A); 32-50% (v/v) of the at least one natural fiber sheet material (B); 0-9% (v/v) of the at least one further polymer component (C) that is different from (A); and 0.05-5% (v/v) of the at least one additive (D).

19. The composite material (K) of claim 16 or claim 17, containing 45-60% (v/v) of the at least one styrene (co)polymer (A); 32-50% (v/v) of the at least one natural fiber sheet material (B); 0-9% (v/v) of the at least one further polymer component (C) that is different from (A); and 0.05-5% (v/v) of the at least one additive (D).

20. The composite material (K) of claim 16 or claim 17, wherein the styrene (co)polymer (A) comprises at least one styrene-acrylonitrile copolymer and/or at least one a-methyl-styrene-acrylonitrile copolymer.

21. The composite material (K) of claim 16 or claim 17, wherein the natural fiber sheet material (B) is a flax fiber sheet material.

22. The composite material (K) of claim 16 or claim 17, wherein the natural fiber sheet material (B) is a fiber fabric having a linear mass density of 100-600 tex.

23. The composite material (K) of claim 16 or claim 17, wherein the natural fiber sheet material (B) is a fiber fabric having a linear mass density of 150-450 tex.

24. The composite material (K) of claim 16 or claim 17, wherein the natural fiber sheet material (B) has a basis weight of 100-600 g/m².

25. The composite material (K) of claim 16 or claim 17, wherein the natural fiber sheet material (B) has a basis weight of 150-450 g/m².

26. The composite material (K) of claim 16 or claim 17, wherein the at least one additive (D) is a release agent or a lubricant and the at least one additive (D) is used in an amount of from 0.05-5% (v/v), based on the total volume of the composite material.

27. The composite material (K) of claim 16 or claim 17, wherein the composite material (K) has a 20′ gloss of at least 40 and a 60′ gloss of at least 70, as measured in accordance with the ISO 2813 (2015) standard.

28. The composite material (K) of claim 16 or claim 17, wherein the styrene (co)polymer (A) has a sufficiently high transparency such that the natural fibers of the natural fiber sheet material (B) are visible on the surface of the composite material (K).

29. A process for producing the fiber-reinforced composite material (K) of claim 16 or claim 17, comprising the following steps:
a) forming a layer assembly of at least one thermoplastic layer composed of the styrene (co)polymer (A), the optional further polymer component (C)_{L} and/or the optional additive component (D);
b) forming a layer assembly of at least one layer of the natural fiber sheet material (B);
c) pressing the stacked layer assemblies of the at least one thermoplastic layer and the at least one layer of the natural fiber sheet material (B) in a heated tool at a temperature of 160-240° C. and at a pressure of 15-25 bar to form the fiber-reinforced composite material (K); and
d) cooling the fiber-reinforced composite material (K) to a temperature below the glass transition temperature (T_{g}) of the styrene (co)polymer (A), at a pressure of 15-25 bar.

30. The process of claim 29, wherein:
a) the layer assembly of the at least one thermoplastic layer has an average thickness of 0.05-0.75 mm;
b) the layer assembly of the at least one layer of the natural fiber fabric (B) has an average thickness of 0.05-0.75 mm;
c) the stacked layer assemblies of the at least one thermoplastic layer and the at least one layer of the of natural fiber fabric (B) are pressed in a heated tool at a temperature of 180-230° C. and at a pressure of 15-25 bar to form the fiber-reinforced composite material (K); and
d) the fiber-reinforced composite material (K) is cooled to a temperature below the glass transition temperature (T_{g}) of the styrene (co)polymer (A), at a pressure of 15-25 bar.

31. The process of claim 29 or claim 30, wherein the cooled composite material (K) has an average thickness of <4 mm.

32. A structural element for building components and/or esthetic applications, comprising the composite material (K) of claim 16 or claim 17.

33. A structural element for building components and/or esthetic applications comprising the composite material (K) produced by the process of claim 29 or claim 30.

34. Starting materials for producing shaped articles by a thermoforming process; film materials or coatings; packaging materials; or textile sheet materials or fabrics, comprising the composite material (K) of claim 16 or claim 17.

35. Starting materials for producing shaped articles by a thermoforming process; film materials or coatings; packaging materials; or textile sheet materials or fabrics, comprising the composite material (K) produced by the process of claim 29 or claim 30.
